(19) United States
(12) Patent Application Publication
(10) Pub. No.: US 2014/0068256 A1
(43) Pub. Date: Mar. 6, 2014

(54) METHODS AND APPARATUS FOR SECURE MOBILE DATA STORAGE

(71) Applicant: BLUEBOX, San Francisco, CA (US)

(72) Inventor: Caleb Sima, San Francisco, CA (US)

(73) Assignee: BLUEBOX, San Francisco, CA (US)

(21) Appl. No.: 14/017,372

(22) Filed: Sep. 4, 2013

Related U.S. Application Data
(60) Provisional application No. 61/696,308, filed on Sep. 4, 2012.

(51) Int. Cl. G06F 21/62

(52) U.S. Cl. CPC G06F 21/6218
USPC 713/165

(57) ABSTRACT

A computer-implemented method for securing data to be stored in a computing device programmed to perform the method includes determining in the computing device, a save request from an application running upon the computing device to an operating system of the computing device to save a file in a memory of the computing device, determining in the computing device, whether a first key is available, and when the first key is available, the method includes automatically encrypting in the computing device, the file using the first key to form an encrypted file, in response to the save request, and automatically requesting with the computing device, the operating system of the computing device to store the encrypted file in the memory.

### CROSS-REFERENCES TO RELATED APPLICATIONS

The present application is a continuation of provisional Application No. 61/696,308; filed on Sep. 4, 2012, the full disclosures of which is incorporated herein by reference.

### FIELD OF THE INVENTION

The present invention relates to secure storage of mobile data. More particularly, some embodiments of the present invention relate to automatically encrypting and decrypting data stored in a memory of a mobile device. Other embodiments relate to automatically encrypting and decrypting data stored in a memory of a remote server by the mobile device.

### SUMMARY OF THE INVENTION

In accordance with the present invention, a method for securitizing data to be stored in a computing device having a computing system programmed to perform the method, is provided. The method comprises the steps of initiating a request to save non-encrypted data, from an application running upon the computing device, to an operating system of the computing device and then determining, in the computing device, whether a first encryption key is available. If the first encryption key is available, the method causes the data to be encrypted, in the computing device by using the first encryption key to form an encrypted file in response to the save request and then saving the encrypted file.

The method can further comprise the steps of receiving, with the computing device, a success indicator from the operating system of the computing device that the encrypted file is stored in the memory and indicating, in the computing device, a successful storage of the file in the memory to the application, in response to the success indicator.

Further, the method of the present invention can include the steps of sending, from the computing device, a request for the first encryption key to a remote server and determining, in the computing device, that the first encryption key is available when the computing device receives the first encryption key from the remote server. If it is determined that the first encryption key is not available the method will indicate, in the computing device, an unsuccessful storage of the file in the memory to the application.

The method can further comprise the steps of determining when the device has made a request to retrieve a file from an application running on the device and requesting, with the computing device, the encrypted file in the memory in response to the retrieve request. The device would then determining the availability of a second encryption key and then decrypt the encrypted file using the second encryption key to recover the file, in response to the retrieve request. Finally, the method provides the encryption file to the application.

In the method of the present invention the step of determining whether the second encryption key is available or not further comprises the steps of sending an identifier associated with the computing device to the remote server and using the identifier to determine if the second encryption key is available.

The method would also include means to indicating, in the computing device, an unsuccessful retrieval of the file from the memory to the application when the second encryption key is not available.

In a further embodiment, the method for securitizing data comprising the steps of determining a save request, from an application running on the device to save a file to a remote server and then determining, in the computing device, whether a first encryption key is available. If the encryption key is available, encrypting the file, using the first encryption key and outputting, with the computing device, the encrypted file to the remote server.

In addition the method can provide for receiving a success indicator from the remote server where the encrypted file is stored and indicating, in the computing device to the user a successful storage of the file in the remote server, in response to the success indicator.

In some embodiments, the method includes sending a request for the first encryption key to a remote security server and indicating that the first encryption key is available from a remote security server if the first key is available. Further, the method can include the steps of determining if the first encryption key is not available and indicating, in the computing device, an unsuccessful storage of the file in the remote server when the key is not available.

The method for securitizing data can comprise the steps of requesting, from the application running upon the computing device, a file from the remote server, then requesting, with the computing device, the operating system of the computing device to retrieve the encrypted file from the remote server. Determining, in the computing device, whether a second encryption key is available and decrypting, in the computing device, the encrypted file using the second encryption key to recover the file, in response to the retrieve request. Then providing, with the computing device, the decrypted file to the application.

In determining in the computing device whether the second key is available the method can send, from the computing device, an identifier associated with the computing device to the remote security server to find if the second encryption key is available then indicating, in the computing device, an unsuccessful retrieval of the file from the remote server when the second encryption key is not available.

A more detailed explanation of the invention is provided in the following description and claims and is illustrated in the accompanying drawings.

### BACKGROUND OF THE INVENTION

With the advent of small mobile electronic devices, such as mobile telephones, now called smart phones, e-tablets, including those from Apple, Microsoft, Google, Amazon and others as well as the advent of applications used thereon, there has developed the need to storage and security of data used, created, modified and necessary to the functioning of these devices and their applications. Users of these devices have, in many cases, adopted the devices to all manner of work and other uses previously prescribed for desk top and lap top computing and the need for data management has not changed, just because the instruments have changed.

However, as with any computer system or device connected to a network and/or the Internet, these devices are subjected to potential hacking and or infiltration by viruses, malware and spy ware designed to interfere with data in devices and even the use of the device including trying to steal data or tamper with it. Further, as these devices are designed to be compact and portable, there is the added danger that the devices themselves, with data therein, can be easily stolen and the data used mischievously or with malice to deprive the user of the data, use the data towards unintended ends or destroy the data at a cost to the data compiler of time and money.

As a result many corporations and government offices that provide smart telephones or other portable electronic devices to employees and others have prohibited and in many cases through the use of administrative properties of the devices barred the devices from accepting applications. In addition users who have suffered the loss of data in such devices have shied away from entrusting a subsequent device with their data.

In various embodiments, the mobile device may be a mobile telephone, such as an iPhone, Galaxy S, and others; a web device such as an iPad®, a Kindle®, a Nexus®, and others; a media player, such as an iTouch®, or the like; this list being illustrative and not exhaustive. Embodiments of the present invention may include a mobile device executing software and/or executable software including at least some of the functionality described herein. In some embodiments of the present invention, the invention monitors operating system calls by various applications running on a mobile device for local file save data save and file retrieve data retrieve commands.

Data for such devices can be in the form of contact information, calendar information, emails and associated files, data created in applications provided on mobile devices and data sent to mobile devices from any source, including desk top and portable computers and/or servers, among other, as well as other data and information that is important to the daily functionality of a person using a mobile device in a modem business or social environment.

It is understood that among the applications, as noted above, that may have data transfers and creation aspect used by mobile device users, some provide clever functionality and are useful for business and other users. Among other things, these applications provide travel assistance, reservations, tracking of flights and analysis of data as well, boarding passes for airlines are now available through such devices, and would be helpful to the users of these devices to be secure in the data used and added to such applications. Further, companies that produce such applications and or the data transferred therein are finding that sales of these apps are compromised by the lack of security for the data used and stored therein, for their purchasers. This lack of security can be crippling to an application producer and their clients and can therefore have deleterious effects on commerce and the survivability of application business.

It would be desirable, therefore to offer reliable, safe and secure data transfer and storage functions generally in mobile devices and specifically to application users and writers such that data can be transferred, stored, created and used in a device without having fear that the data could be compromised and or damaged due to a lack of security.

### BRIEF DESCRIPTION OF THE DRAWINGS

FIG. 1 is a representation of a system using the method of the present invention;

FIG. 2 is another representation of a system using the method of the present invention;

FIG. 3 is a flow chart of the functionality of the present invention; and

FIG. 4 is a further flow chart of the functionality of the present invention.

FIG. 5 is a further flow chart of the functionality of the present invention; and

FIG. 6 is a further flow chart of the functionality of the present invention.

### DETAILED DESCRIPTION OF THE ILLUSTRATIVE EMBODIMENT

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application “Detailed Description of an Illustrative Embodiment” relates to a requirement of the United States Patent Office, and should not be found to limit the subject matter disclosed herein.

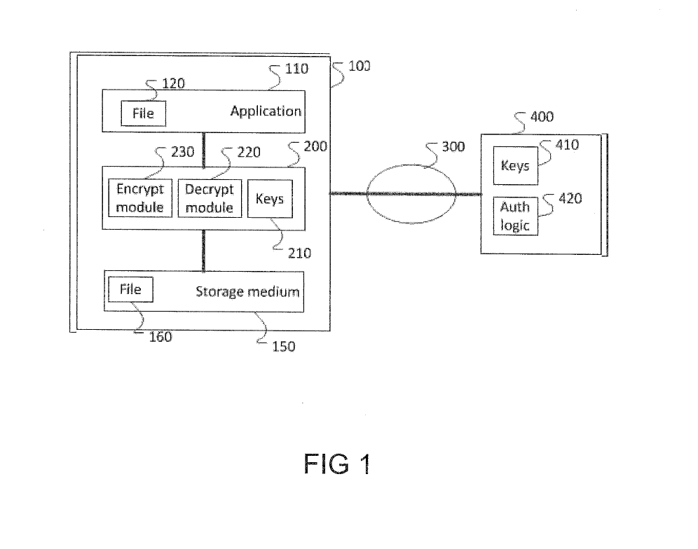

Referring to the drawings, FIG. 1 shows a mobile device 100 which runs a mobile application 110. At times, the application 110 may have a file 120 it wants to transfer to a storage medium 150. At other times, the application 110 may desire to retrieve a file 160 from a storage medium 150.

The present invention involves, inter alia, inserting logic 200 between the application 110 and the storage medium 150. When the application 110 wishes to store a file 120 onto the storage medium 150, the logic 200 receives the file 120 and performs an encryption operation on the file via an encryption module 230 utilizing a security key 210. Afterwards the logic 200 transfers the encrypted version of the file to the storage medium 150 for final storage. This results in an encrypted version of the file 160 on storage medium 150.

When the application 110 wishes to retrieve a file 160 from the storage medium 150, the logic 200 receives the file 160 and performs a decryption operation on the file via a decryption module 220 utilizing a security key 210. Afterwards, the logic 200 transfers the decrypted version of the file to the application 110 for application use. This results in a decrypted/original version of the file 120 for use by the application 110.

In some situations, the logic 200 may not contain the appropriate key 210 for use with the encryption module 230 or decryption module 220. The logic 200 would return an error response to the application 110 to indicate a file store or retrieval failure. Or the logic 200 can continue to search for an encryption key, as discussed in more detail below.

In situations where the logic 200 does not contain the appropriate key 210 for as noted above, the application can have functionality such that the logic 200 will communicate across a communications network 300 to a key security service 400; the service will use authentication logic 420, of a type known to persons having ordinary skill in the art, to verify access to key 410. Once access is verified, the security service 400 can then return key 410 back to the logic 200 for use with the encryption module 230 and decryption module 220 to encrypt the data.

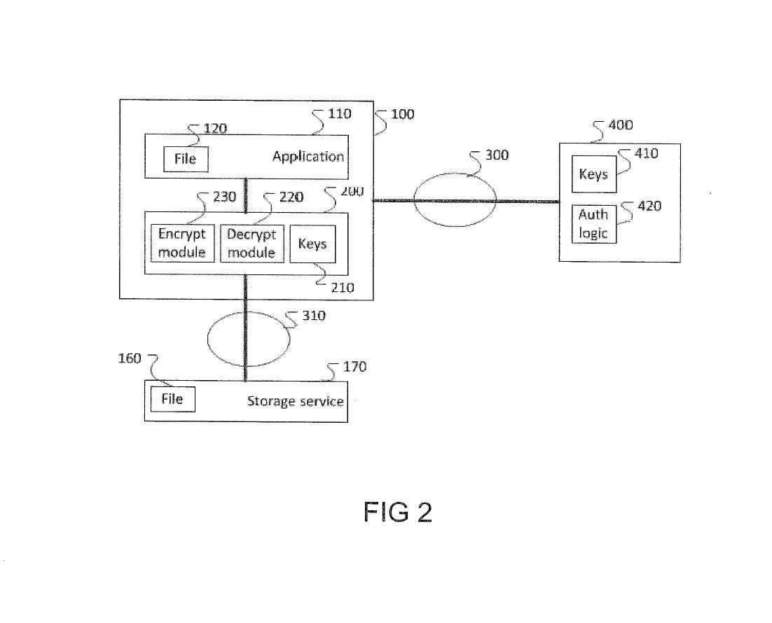

Referring now to FIG. 2, a mobile device 100 is shown, running a mobile application 110. At times, the application 110 may have a file 120 that there is a desire to transfer to a storage service 170 over communications network 310. At other times, the application 110, or the person running the application, may desire to retrieve a file 160 from a storage service 170 over communications network 310. In such situations, the present invention includes inserting logic 200 between the application 110 and the storage service 170 as described below.

When the user via the application 110 wishes to store a file 120 onto the storage service 170, the logic 200 receives the file 120 and performs an encryption operation on the file via an encryption module 230 utilizing a security key 210. Afterwards the logic 200 transfers the encrypted version of the file to the storage service 170 for final storage. This results in an encrypted version of the file 160 on storage service 170. Concomitantly, when the application 110 wishes to retrieve a file 160 from the storage service 170, the logic 200 receives the file 160 and performs a decryption operation on the file via a decryption module 220 utilizing a security key 210. Afterwards, the logic 200 transfers the decrypted version of the file to the application 110 for application use. This results in a decrypted/original version of the file 120 for use by the application 110. It will be understood, by persons having ordinary skill in the art that the operations described can occur in the background and with such speed that their use is unnoticed by the user.

In some situations, the logic 200 may not contain the appropriate key 210 for use with the encryption module 230 or decryption module 220. The logic 200 would return an error response to the application 110 to indicate a file store or retrieval failure. Or the logic 200 can continue to search for an encryption key, as discussed in more detail below.

In situations where the logic 200 may not contain the appropriate key 210 for use with the encryption module 230 or decryption module 220. The logic 200 can communicate across a communications network 300 to a key security service 400. The service will use authentication logic 420 to verify access to key 410, and then return key 410 back to the logic 200 for use with the encryption module 230 and decryption module 220.

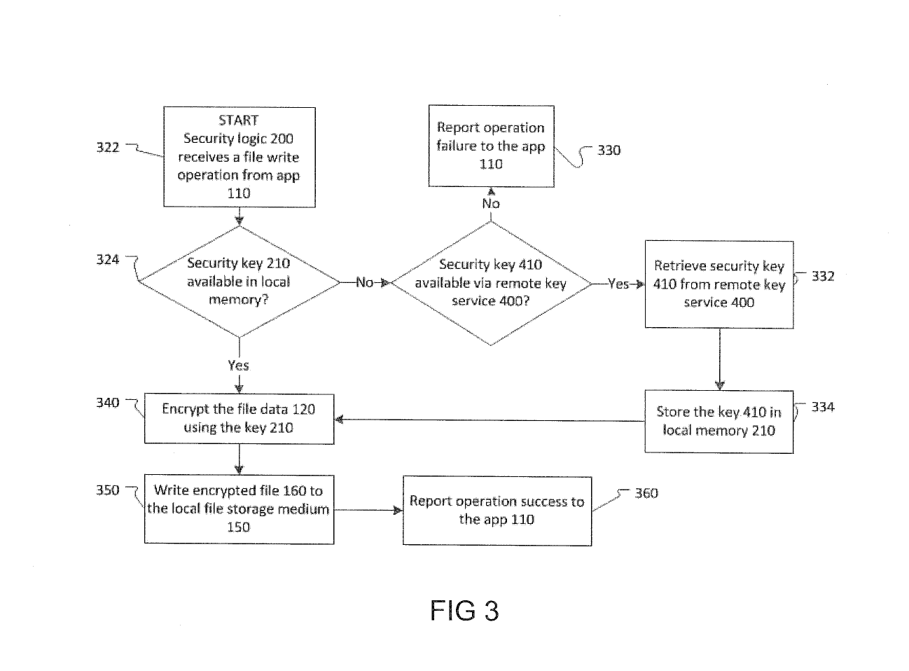

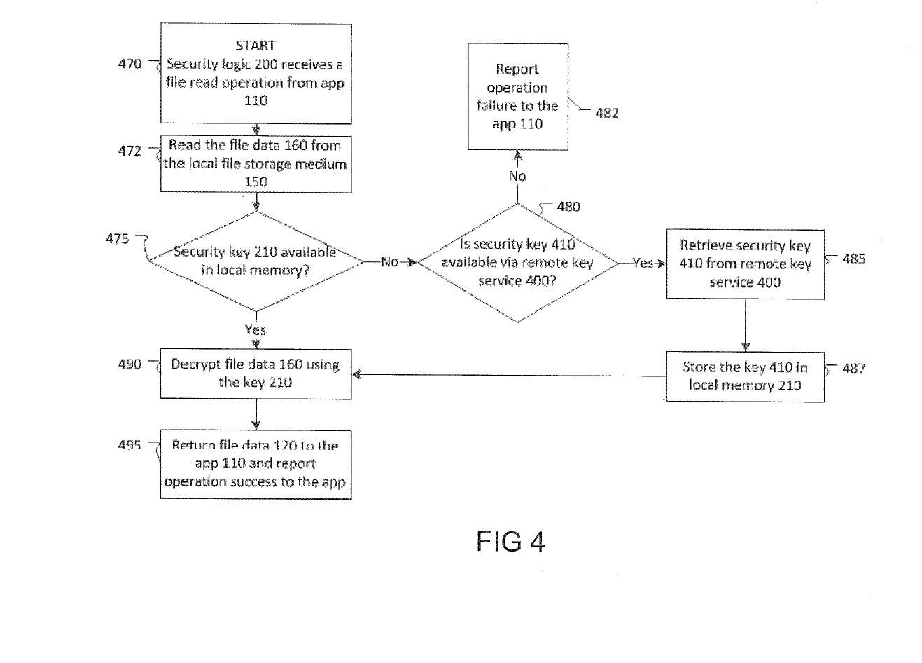

Referring now to FIGS. 3 and 4, flow charts of preferred processes of the present invention are shown. It will be understood that some of the elements of the flow charts, FIG. 3 and FIG. 4, come from the elements illustrated and explained above with respect to FIGS. 1 and 2, where necessary the elements of FIGS. 1 and 2 will be noted in the description of the flow charts. It will be understood that other elements can be substituted by persons having ordinary skill in the art, so as to maintain the functionality of the invention, without departing from the novel scope of the present invention.

As illustrated, the flow chart of FIG. 3 shows the steps and considerations for securing mobile data storage, as will be seen secure logic 200, at the start 322, receives a file write operation or command 322 from the application 110. The system then checks 324 to see if a secure key 210 is available in the local memory of the mobile device 100 and if not a check is made to see if a security key 410 is available at the remote server, such as security service 400. If there is no secure key 410 then the system reports operation 330 failure to the application 110. If however, the security key 410 is available at the remote server, the system causes the key to be retrieved 332 and causes the key to be stored 334 in the local memory of the mobile device 100.

Once the encryption secure key is available, either originally in the local memory 324 or as a result of its acquisition 332 from the remote server, the system encrypts 340 the data using either key 210, 410. The encrypted data is then written to the local file storage medium within the mobile device 100. The system then reports 360 the successful storage to the application.

FIG. 4 is a further embodiment of a system made in accordance with the present invention. Secure logic 200, at the start 470, receives a file read operation or command 470 from application 110. The system reads 472 file data 160 from the local file storage medium 150. The system then checks 475 to see if a secure key 210 is available in the local memory of the mobile device 100 and if not a check 480 is made to see if a security key 410 is available at the remote server, such as security service 400. If there is no secure key 410 then the system reports operation 482 failure to the application 110. If however, the security key 410 is available at the remote server, the system causes the key to be retrieved 485 and causes the key to be stored 487 in the local memory of the mobile device 100.

Once the decryption secure key is available, either originally in the local memory 475 or as a result of its acquisition 485 from the remote server, the system decrypts 490 the data using either key 210, 410. The system then transfers 495 the decrypted file 120 to the application 110 and reports 495 an operation success status to application.

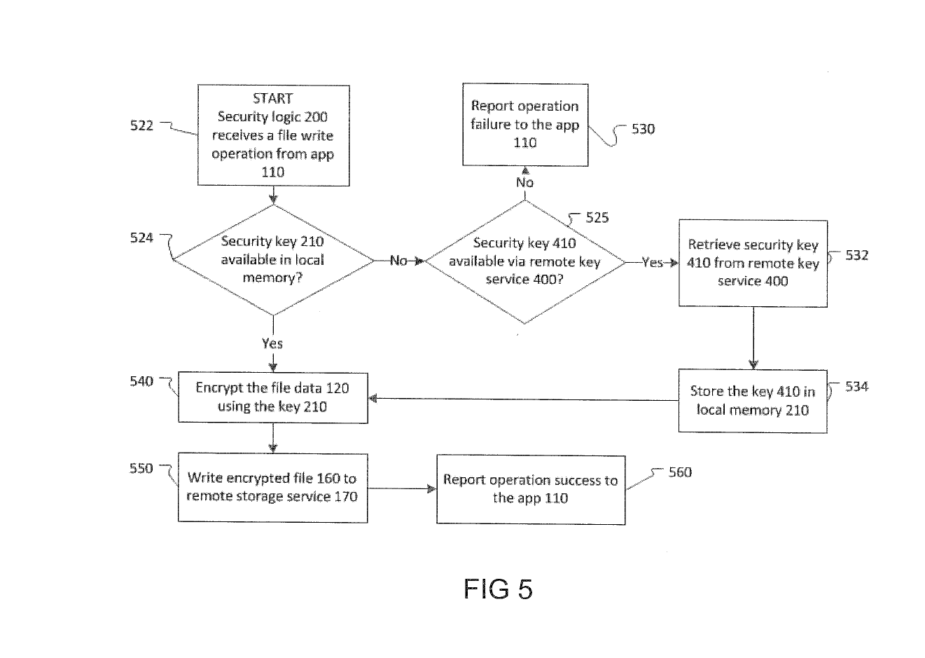

As illustrated, the flow chart of FIG. 5 shows the steps and considerations for securing mobile data storage to a remote storage service, as will be seen secure logic 200, at the start 522, receives a file write operation or command 522 from the application 110. The system then checks 524 to see if a secure key 210 is available in the local memory of the mobile device 100 and if not a check 525 is made to see if a security key 410 is available at the remote server, such as security service 400. If there is no secure key 410 then the system reports operation failure 530 to the application 110. If however, the security key 410 is available at the remote server, the system causes the key to be retrieved 532 and causes the key to be stored 534 in the local memory of the mobile device 100.

Once the encryption secure key 410 is available, either originally in the local memory 524 or as a result of its acquisition 532 from the remote server, the system encrypts 540 the data using either key 210, 410. The encrypted data is then written 550 to the remote storage service 170. The system then reports 560 the successful storage to the application.

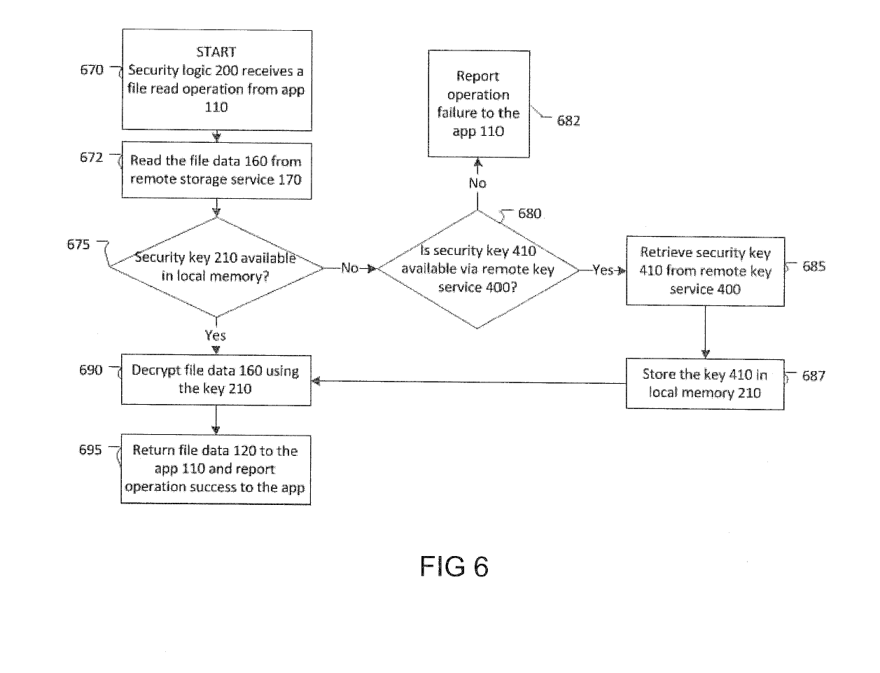

FIG. 6 is a further embodiment of a system made in accordance with the present invention. Secure logic 200, at the start 670, receives a file read operation or command 670 from application 110 for a file on remote storage 170. The system reads 672 file data 160 from the remote storage service 170. The system then checks 675 to see if a secure key 210 is available in the local memory of the mobile device 100 and if not a check 680 is made to see if a security key 410 is available at the remote server, such as security service 400. If there is no secure key 410 then the system reports operation 682 failure to the application 110. If however, the security key 410 is available at the remote server, the system causes the key to be retrieved 685 and causes the key to be stored 687 in the local memory of the mobile device 100.

Once the decryption secure key is available, either originally in the local memory 675 or as a result of its acquisition 685 from the remote server, the system decrypts 690 the data using either key 210, 410. The system then transfers 695 the decrypted file 120 to the application 110 and reports 695 an operation success status to application.

It will be understood then, that in response to an application calling the operating system file save command API, some embodiments of the invention will intercept the command, automatically encrypt the file data, and then automatically call the operating system file save command to save the encrypted file. Upon successful storage of the encrypted file, these embodiments of the present invention will respond back to the application that the original file save command was successful.

In various embodiments of the present invention, in response to an application calling the file retrieve command API, the embodiments of the invention will intercept the command, automatically call the operating system file retrieve command API to obtain the encrypted file, and then automatically decrypt the encrypted file data to obtain the original file data. These embodiments of the invention can then provide the original file data back to the application such that they help secure storage of data upon the mobile device.

In some embodiments of the present invention, the dynamic encryption and decryption of file data may be extended for storage of the file data onto remote storage cloud servers, such as DropBox®, Box.Net®, iCloud®, and others, as known by persons having ordinary skill in the art. In various embodiments of the present invention, initially, an application such as a DropBox® application or the mobile device operating system will choose, either through internal commands or at the request of the user, to store or mirror file data to a remote storage server. Similar to the embodiments above, in response to such a choice, embodiments of the present invention will intercept the file save command, encrypt the file data with a encryption key, and then sends the encrypted file to the remote storage server. If the remote storage server indicates successful storage of the encrypted file, embodiments report back to the application or mobile device operating system, that the file is stored.

In various embodiments of the present invention, when application or the mobile device operating system or the user, chooses to retrieve file data from a remote storage server, such as described in the embodiments noted above, these embodiments will intercept the command and request that the remote storage server return the encrypted file data. Once the encrypted file data is retrieved from the remote storage server, these embodiments decrypt the file data with a decryption key, and then send the recovered original file to the application or mobile device operating system. It will be understood that these types of embodiments help secure storage of data upon cloud servers.

In various embodiments of the present invention, the encryption process may use a symmetric or asymmetric key for encryption. Additionally, the keys may be resident upon the mobile device or may be dynamically retrieved from a remote server on demand. Further, the keys may be time sensitive and may require some level of authorization before the keys are provided or are activated.

In one example, when an application attempts to locally save a file, embodiments dynamically contact a remote server for an encryption key. In some cases, for example if the mobile device has not been reported lost, missing, stolen, or the like, the remote server provides the encryption key to the mobile device to encrypt the data.

When the application attempts to retrieve the file, embodiments may dynamically contact the remote server for a decryption key. In some cases, such as if the mobile device has not been reported lost, missing, stolen, or the like, the remote server provides the decryption key to the mobile device to enable decryption of the data, as described above.

In another example, the encryption key, for example a public key resides upon the mobile device, is used such that data encryption can be performed without the mobile device having to access the remote server for the encryption key. In this example, the decryption key, that is a private key, may be retrieved as described above. In the case where a user reports to the remote server that their mobile device is lost, stolen, or the like, then when an application running the mobile device attempts to retrieved stored data, the remote server does not provide the necessary decryption key, thus causing the decryption process to fail. Accordingly the encrypted data stored upon the mobile device remains secure.

In still other examples, encryption/decryption keys both reside upon the mobile device and become available for use, as described herein, after the mobile device is unlocked; thereby using the mobile device's own security systems to augment the security provided herein.

Other embodiments of the present invention do not require security keys to be resident upon the mobile device. In some of these embodiments, when a user is coupled to a VPN, the VPN server may monitor file save/file retrieve traffic commands by a mobile device. In additional cases, when the VPN server sees a file save command along with file data, the VPN server can intercept the file data, encrypt the data with a key, and then provide the encrypted file data along with the file save command to the appropriate network destination.

In some embodiments of the present invention, when the VPN server sees a file-retrieve command along with a storage address from a mobile device, the VPN server can intercept the encrypted file retrieved from the storage address, decrypt the encrypted file data with a key, and then provide the decrypted file data back to the mobile device. Such embodiments can rely upon the user being able to provide appropriate credentials to log into to the VPN server, or rely upon a specific login authentication.

Further embodiments can be envisioned to one of ordinary skill in the art after reading this disclosure. In other embodiments, combinations or sub-combinations of the above disclosed invention can be advantageously made. For example, the above techniques may also be implemented upon a personal computer e.g. desktop, laptop, or the like. In some embodiments, software installed upon the personal computer may also intercept data save and/or data retrieve commands sent to the operating system and encrypt and decrypt the data on the fly. In additional embodiments, software installed upon the personal computer may also intercept data save and/or retrieve commands sent up client software of cloud-based storage systems such as Dropbox®, Box.net®, iCloud®, or the like. The block diagrams of the architecture and flow charts are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A method for securitizing data to be stored in a computing device having a computing system programmed to perform the method, comprising the steps of:
initiating a request to save non-encrypted data, from an application running upon the computing device, to an operating system of the computing device;
determining, in the computing device, whether a first encryption key is available and if the first encryption key is available, causing the data to be encrypted, in the computing device, using the first encryption key to form an encrypted file in response to the save request; and
saving the encrypted file.

2. The method for securitizing data of claim 1, further comprising the steps of:
receiving, with the computing device, a success indicator from the operating system of the computing device that the encrypted file is stored in the memory; and
indicating, in the computing device, a successful storage of the file in the memory to the application, in response to the success indicator.

3. The method for securitizing data of claim 1, further comprising the steps of:
sending, from the computing device, a request for the first encryption key to a remote server;
determining, in the computing device, that the first encryption key is available when the computing device receives the first encryption key from the remote server.

4. The method for securitizing data of claim 3, further comprising the steps of:
determining, in the computing device, that the first encryption key is not available; and
indicating, in the computing device, an unsuccessful storage of the file in the memory to the application.

5. A method for securitizing data to be stored in a computing device having a computing system programmed to perform the method, comprising the steps of:
determining, in the computing device, a retrieve request, from the application running upon the computing device, to the operating system of the computing device, to retrieve the file;
requesting, with the computing device, the encrypted file in the memory in response to the retrieve request;
determining the availability of a second encryption key;
decrypting, in the computing device, the encrypted file using the second encryption key to recover the file, in response to the retrieve request; and
providing, with the computing device, the encryption file to the application.

6. The method for securitizing data of claim 5, wherein the step of determining in the computing device whether the second encryption key is available or not further comprises the steps of:
sending, from the computing device, an identifier associated with the computing device to the remote server; and
determining, in the computing device, that the second encryption key is available when the computing device receives the second encryption key from the remote server

7. The method for securitizing data of claim 6, further comprising the step of indicating, in the computer device, an unsuccessful retrieval of the file from the memory to the application when the second encryption key is not available.

8. A method for securitizing data to be stored in remote server by a computing device programmed to perform the method comprising the steps of:
determining, in the computing device, a save request, from an application running upon the computing device to an operating system of the computing device, to save a file in a remote server;
determining, in the computing device, whether a first encryption key is available;
encrypting, in the computing device, the file, using the first encryption key to form an encrypted file, in response to the save request; and
outputting, with the computing device, the encrypted file to the remote server.

9. The method for securitizing data of claim 8, further comprising the steps of:
receiving, with the computing device, a success indicator from the remote server where the encrypted file is stored; and
indicating, in the computing device, a successful storage of the file in the remote server, in response to the success indicator.

10. The method for securitizing data of claim 8, further comprising the steps of:
sending, from the computing device, a request for the first encryption key to a remote security server; and
determining, in the computing device, that the first encryption key is available when the computing device receives the first encryption key from the remote security server.

11. The method for securitizing data of claim 10, further comprising the steps of:
determining if the first encryption key is not available; and
indicating, in the computing device, an unsuccessful storage of the file in the remote server.

12. A method for securitizing data to be stored in a computing device having a computing system programmed to perform the method, comprising the steps of:
requesting, from an application running upon the computing device, a file from a remote server;
requesting, with the computing device, the operating system of the computing device to retrieve an encrypted file from the remote server;
determining, in the computing device, whether a second encryption key is available;
decrypting, in the computing device, the encrypted file using the second encryption key to recover the file, in response to the retrieve request; and
providing, with the computing device, the decrypted file to the application.

13. The method for securitizing data of claim 12, wherein determining in the computing device whether the second key is available comprises the steps of:
sending, from the computing device, an identifier associated with the computing device to the remote security server; and
determining, in the computing device, that the second encryption key is available when the computing device receives the second encryption key from the remote security server

14. The method for securitizing data of claim 12, further comprising the step of indicating, in the computing device, an unsuccessful retrieval of the file from the remote server when the second encryption key is not available.
